(19) United States
(12) Patent Application Publication
(10) Pub. No.: US 2005/0061750 A1
(43) Pub. Date: Mar. 24, 2005

(54) Methods for the purification of contaminated waters

(75) Inventors: Jon O. Fabri, Charleston, SC (US); Jason Holt, Acworth, GA (US)

Correspondence Address: NELSON MULLINS RILEY & SCARBOROUGH LLP, P.O. BOX 11070, COLUMBIA, SC, 29211, US

(73) Assignee: Polymer Ventures, Inc., Charleston, SC (US)

(21) Appl. No.: 10/946,731

(22) Filed: Sep. 22, 2004

Related U.S. Application Data
(60) Provisional application No. 60/505,292, filed on Sep. 23, 2003.

(51) Int. Cl. C02F 1/52

(52) U.S. Cl. 210/728

(57) ABSTRACT

The present invention describes a method for the purification of waters containing high levels of contaminants by sequentially intermixing with the contaminated water a first anionic polymer, a cationic polymer, and a second anionic polymer, and then separating the contaminants from the water.

### CROSS REFERENCE TO RELATED PATENTS AND PATENT APPLICATIONS

The subject matter of the present invention is related to and claims the benefit of U.S. Provisional Patent Application Ser. No. 60/505,292, filed Sep. 23, 2003, which is incorporated herein in its entirety.

### BACKGROUND OF THE INVENTION

(1) Field of Invention

The present invention relates to methods for the clarification of wastewater and, more particularly to methods of clarifying water containing high levels of contaminants.

(2) Description of Related Art

Much importance has recently been placed on the reduction of effluent levels of contaminants in wastewater streams due to environmental considerations. For instance, the high demand on water resources and landfills resulting from increased industrialization and population growth are problems facing the global community. With the environmental regulations becoming increasingly more stringent, there is a growing need for more efficient and cost effective methods for abatement. For practical, economic and environmental reasons, water must be separated from contaminants and re-used or discharged into the environment.

Contaminants in wastewater often cause the water to appear turbid or colored. These contaminants include suspended and colloidal materials and soluble substances. Because the density of many of these particles is only slightly greater than water, agglomeration or aggregation of particles into a larger floc is often necessary in order for them to be removed by sedimentation. The clarified water then can be either discharged or reused and the settled floc can be collected, dewatered and recycled or disposed of as a solid material.

Moreover, industrial wastewater generally contains contaminants such as suspended solids, dissolved organic matters, and heavy metals at levels considered hazardous to the environment and which could pose a risk to public health. Such contaminants must be removed or their levels reduced to legally acceptable levels prior to discharging the water to the environment.

For example, contaminated surface runoff from disturbed areas of operating mines is a major source of suspended solids which can adversely affect the environment around these mines. The disturbed areas are usually large and include such items as the mine pits, beneficiation plants and related facilities, mine dumps, tailings, ponds, roads, ditches, and the like.

The dewatering and disposal of mineral tailings in wastewater poses a major technological and environmental challenge to the mining and mineral processing industry worldwide. Mineral recovery requires the processing of very large volumes of contaminated wastewater. The mining of heavy minerals, such as various titanium ores, is typical of such mining operations.

Titanium ore mining involves the creation of a large artificial freshwater pond on which a mechanical dredge floats. The dredge is equipped with a cutterhead that digs into the sub-surface soil removing overburden, ore and water. The dredge uses buckets on a continuous chain or rotary cutting heads and a suction hose to remove material from various depths below the water surface. At one end of the pond, the dredge draws in overburden, ore and water and transfers the mixture to a floating wet mill. The wet mill equipment separates the desired mineral ore particles from the overburden. Boom conveyors on the dredge then deposit the waste (tailings) back into the area already mined behind the suction dredge.

The dredge water often picks up humate type organic waste material (humate) from the soil. Humic acid or humate is a brown to black polymeric constituent of soils, lignite and peat containing aromatic and heterocyclic structures and carboxyl groups. Humid acid is naturally formed from the decomposition of cellular substances and decaying plant life.

Eventually, process water or wastewater containing humate is released into dredge ponds or impounded areas as a discolored colloidal suspension. The wastewaters can contain 1-10% by weight of solid contaminants, of which greater than 50% can be organic in nature. These dredge ponds can create serious environmental problems that involve surface-water and ground water contamination.

In order to clarify wastewater streams, such as dredge pond water, the solid contaminants are often simply allowed to settle by gravity. Most of the suspended matter in water will settle, given enough time, but in many cases the amount of time required is too long to be practical. Gravity settling of the suspended materials in typical dredge pond wastewaters, in fact, can take a number of years. The time required for settling is dependent on many factors, including the weight of the particles in the wastewater, the shape of the particles, sizes of the particles and viscosity and/or frictional resistance of the water. Unfortunately, while a degree of clarification can be accomplished by gravity settling, most industrial processes and environmental regulations require better quality water than can be obtained from this settling alone.

Alternatively, flocculants and/or coagulants may be employed to concentrate the suspended solids, thus aiding in their removal from wastewater. It has been reported that there are various situations where it is desirable to flocculate and/or coagulate a colloidal suspension utilizing cationic polymers alone, anionic polymers alone, or cationic polymers in combination with anionic polymers. Most often, a cationic polymer is the major component.

Even though many flocculant and coagulant compounds have been reported as effective for reducing the solids content in a wastewater stream, their effectiveness could still be improved. For example, cationic polymers alone do not interact with all the different species of solid contaminants. Moreover, many cationic polymers are known to introduce some degree of toxicity to the wastewater when used alone. Anionic polymers are also problematic in that high concentrations may hinder the eventual settling of the flocs.

As mentioned above, in the mining and beneficiation of titanium dioxide ores (e.g. anatase and rutile) large volumes of water are used and generated. These waters contain high levels of organic waste solids in the form of humates and the like. A typical water analysis of this wastewater is 1-10 weight percent solids, of which greater than 50 percent are organic in nature. This organic content can be determined by ash analysis or loss on ignition (LOI) of the solids. Typical water treatment processes have previously been ineffective for efficiently separating these organics from the wastewater. For example, conventional processes for the clarification of mining wastewater involve adding sulfuric acid (H₂SO₄) to the wastewater to lower the pH to 3.5. This action induces flocculation of organic matter and leaves a clear supernate, which is decanted from the settling ponds. The clear water is then neutralized to pH 7 with lime and discharged to public streams.

To date, no particular combination of flocculants and/or coagulants has been completely effective in separating all solids from a wastewater stream of the type encountered in titanium dioxide mining operations. The failure by these conventional dewatering techniques to achieve acceptably high solids consolidation with minimum water retention over long periods of time has prompted a search for improved methods for dewatering and clarification of wastewater streams.

From the foregoing, it can be seen that a need exists for improved methods for removing contaminants from a wastewater stream. It would also be useful to provide an improved method and composition for concentrating an aqueous suspension of inorganic and/or organic solids. In particular, methods that offer improved processes for reducing the concentration of humate type organic impurities in a wastewater stream would be useful. It would also be useful if such method made efficient use of land area in dewatering the solids that had been removed from the wastewater. Finally, a method of clarifying wastewater containing high levels of organic contaminants would be useful.

### SUMMARY OF THE INVENTION

Briefly, the present invention is directed to a novel method of removing contaminants from a wastewater, comprising:
a) intermixing a first anionic polymer with the wastewater;
b) intermixing a cationic polymer with the wastewater and forming a complex between the contaminants and the cationic polymer; and
c) intermixing a second anionic polymer with the wastewater and forming a floc which contains the contaminants.

The present invention is also directed to a novel method for clarifying humate-containing wastewater generated during the mining of titanium dioxide, the method comprising:
a) intermixing a first anionic polymer with the wastewater in an amount of between 10 ppm and 100 ppm, wherein the first anionic polymer is a copolymer comprising about 5 to about 50 mol percent sodium acrylate and with the remainder being acrylamide;
b) intermixing a cationic polymer with the wastewater in an amount of between 50 ppm and 300 ppm, wherein the cationic polymer is poly(diallyldimethylammonium chloride), and forming a complex between the contaminants and the cationic polymer; and
c) intermixing a second anionic polymer with the wastewater in an amount of between 2 ppm and 20 ppm, wherein the second anionic polymer is a copolymer comprising about 5 to about 50 mol percent sodium acrylate and with the remainder being acrylamide, and forming a floc which contains the contaminants.

Several advantages are achieved by the present invention, including the provision of an improved method for removing solid contaminants from a wastewater stream and the provision of an improved method for reducing the concentration of humate type organic impurities in wastewater. Also, the present invention provides a method that makes efficient use of land area used for dewatering the solids that have been removed from the wastewater.

### DESCRIPTION OF THE PREFERRED EMBODIMENTS

In accordance with the present invention, it has been discovered that the sequential addition of a combination of ionic polymers to wastewater that is contaminated with inorganic and/or organic solids will effectively complex all, or at least a part of, the solids and cause the formation of flocs that are then easily separated from the clarified water. It has been found to be preferred that the ionic polymers are added to the wastewater in a certain sequence, namely, a first anionic polymer is added to and intermixed with the wastewater. Following the addition of the first anionic polymer, a cationic polymer is intermixed with the wastewater. Following the addition of the cationic polymer, a second anionic polymer is intermixed with the wastewater.

Sequentially intermixing the ionic polymers of the present invention into wastewater provides several unexpected advantages, including, for example, a reduction in the viscosity of the wastewater. This can be important in situations where wastewater develops an undesirably high viscosity due to a high percentage of contaminants. During the processing of ore for the recovery of titanium dioxide, for example, the application of the present method to process waters enhances the efficiency and the purity of the titanium dioxide recovery.

As used herein, the term “contaminant” means an undesirable organic or inorganic substance not normally present, or an unusually high concentration of a naturally occurring substance, in water or other environmental medium. The term “contaminated” refers to the presence of such contaminant. Likewise, as used herein, the term “contamination” refers to the introduction into water of microorganisms, chemicals, toxic substances, wastes, or wastewater in a concentration that makes the water unfit for its next intended use.

As used herein, the term “wastewater” refers to contaminated liquid, preferably an aqueous liquid, and more preferably water, having solids from a community and/or from industrial processes such as mining that eventually flows to a treatment plant, dredge pond, or collecting pond. Process waters that are used in the mining, separation, transportation, or suspension of minerals in an industrial process are also encompassed by the term “wastewater”. The wastewater can be of the type that is recirculated or recycled in an industrial process, such as, for example, process water that is continuously reused during the mining and preparation of such mineral ores as titanium oxides and phosphates. As used herein, the term “titanium oxides” refers to any and all types of titanium oxide minerals, including, but not limited to, TiO, TiO₂ (titanium dioxide), Ti₂O₃ and Ti₃O₅.

The wastewater that can be treated by the present method includes mineral slurries, such as are encountered, for example, in the processing of phosphate rock, phosphogypsum, red mud, coal fines, clays, kaolin, coal refuse, sand and gravel washing, and sludge conditioning, among others. In these cases, the suspended or colloidal material being removed can be mostly inorganic.

Without being bound by this or any other theory, it is believed that finely dispersed solids suspended in wastewaters are stabilized by electric charges on their surfaces, causing them to repel each other. Since this prevents these charged particles from colliding to form larger masses, they do not settle, or settle extremely slowly. To assist in the removal of these particles from suspension, novel methods of chemical coagulation and flocculation are provided herein by the present invention. These methods, usually done in sequence, are a combination of chemical and physical procedures. In brief, ionized chemicals are mixed with wastewater to promote the aggregation of the suspended solids into particles large enough to settle or be removed (flocs).

Once the suspended solid particles are aggregated into flocs, they can be removed from the liquid by sedimentation, provided that a sufficient density difference exists between the suspended matter and the liquid. Such particles can also be removed or separated by media filtration, straining or flotation. In fact, in one embodiment, wastewater can be pumped out of a sludge pond, for example, and subjected to the novel treatment. The treated wastewater in which the contaminants have been aggregated into flocs can be merely pumped onto land adjacent the pond and the clear water will separate from the flocs and can run back into a pond—clear and free of solid contaminants. The deposited flocs can then be easily gathered for disposal or use. In another embodiment, the flocs produced by the process of the invention can be separated by use of a settling vessel, belt press, centrifuge, or other mechanical means.

Before treatment the wastewater may contain as much as 6 weight percent or more of suspended solids and after clarification with the methods of the present invention, the solids content is often reduced to less than 0.5 weight percent. The present invention is unexpectedly effective for reducing the color, suspended solids, and turbidity of the wastewater of a high solids content wastewater stream. However, the methods of the present invention are also intended to encompass the reduction of the solids content of a wastewater stream when the weight percentage solids are much less than 6 percent or are even greater than 6 percent.

As used herein, the terms “suspended solids” refer to solid particles that either float on the surface or are suspended in water or any other liquid. For the purposes of the invention, the terms “suspended solids” may also refer to dissolved solids. The dissolved solids may become insoluble, and thus suspended, during the course of treatment and subsequently removed from the system in the form of flocs or sludge cake. The term “floc” refers to aggregations of suspended particles or solids resulting from the addition of flocculants and/or coagulants to the wastewater to form small clumps or tufts. The terms “sludge cake” refer to the slurry of solids after separation from water during processing. The sludge cake may contain from about 5% to about 90% moisture after separation from the treated wastewater.

In one embodiment, the wastewater that is in need of clarification may have a percent solid content of between about 0.1-50 weight percent solids, of which greater than 10 percent is organic in nature. In other embodiments, the wastewater that is in need of clarification may have a percent solid content of between about 1-10 weight percent solids, of which greater than 20 percent is organic in nature. In still other embodiments, the wastewater that is in need of clarification may have a percent solid content of between about 3-7 weight percent solids, of which greater than 50 weight percent is organic in nature.

In one embodiment, the majority of these organic solids are of the humate type of organic solids (“humates”). In one embodiment, the organic solids comprise greater than 50 weight percent of the humate type of organic solids. In another embodiment, the organic solids comprise greater than 75 weight percent of the humate type of organic solids. In still further embodiments, the organic solids consist only of the humate type of organic solids. As used herein, the terms “humus”, “humate” or “humic acid” refer to any organic portion of the soil remaining after decomposition.

In another embodiment the majority, or all, of the solids are inorganic materials, such as minerals, metal oxides, fly ash, silt, and/or clays. Such inorganic solids are typically found in wastewaters at levels of from about 1% to about 4% by weight, but the concentrations can be either higher or lower than those levels. Any or all of these materials can be referred to herein as “solid contaminants”. Wastewaters containing inorganic solids are typically aqueous and can be slurries, suspensions, dispersions, colloidal dispersions, or any other type of liquid/solid mixture, all of which are included in the terms “aqueous mixtures”.

Many methods of wastewater clarification use ionic polymers. However, none are believed to use the sequence of ionic polymers in the manner provided by the present invention, or to successfully clarify wastewaters having the type and concentration of organic loading as described herein. As used herein, the term “ion” or “ionic” or “ionized” refers to an electrically charged atom, polymer, radical, or molecule formed by the loss or gain of one or more electrons.

In one embodiment, particulate solids are removed from wastewater by first adding to the wastewater an ionic polymer such as a first anionic polymer in an amount sufficient to form a first anionic polymer/solids complex. A cationic polymer is then added in an amount sufficient to allow the first anionic polymer/solids complex to complex further with the cationic polymer to form an aqueous coacervate with the first anionic polymer/solids complex. Next, the addition of a second anionic polymer further aggregates the coacervated material into flocs, and also has the advantage of apparently at least partially detoxifying the cationic polymer. The flocs are then separated from the wastewater in a conventional manner such as by filtration, settling, or sedimentation. The clarified water can then be returned to the environment or to the industrial operation, or utilized as water suitable for consumption.

As used herein, the term “clarification” means the process of removing contaminants from a liquid. The terms “colloid” or “colloidal” refer to very small, finely divided solids or particulates (particles that do not dissolve under ambient conditions) that remain dispersed in a liquid for a long time due to their small size and electrical charge.

As used herein, the term “particulate” refers to very small solid particles suspended in water that can vary widely in size, shape, density, and electrical charge. Colloidal and dispersed particulates are gathered together by the processes of coagulation and flocculation.

The present invention provides a method for removing contaminants from a wastewater, the method comprising intermixing a first anionic polymer with the wastewater; intermixing a cationic polymer with the wastewater and forming a complex between the contaminants and the cationic polymer; and intermixing a second anionic polymer with the wastewater and forming a floc which contains the contaminants.

The present invention also provides a method for removing solid contaminants from a wastewater stream, comprising adding a first anionic polymer, adding a cationic polymer in an amount sufficient to complex the solid contaminants, adding a second anionic polymer and separating the complexed solid contaminants from the wastewater stream.

In another embodiment, the present invention provides a method for concentrating an aqueous suspension of organic solids comprising the steps of adding a first anionic polymer, adding a cationic polymer in an amount sufficient to complex the organic contaminants, and adding a second anionic polymer.

In still another embodiment, the present invention provides a method for reducing the concentration of humate type organic impurities in a wastewater stream, comprising adding a first anionic polymer, adding a cationic polymer in an amount sufficient to complex the organic contaminants, and adding a second anionic polymer.

In yet another embodiment, the present invention provides a method of clarifying wastewater containing high levels of organic contaminants, the method comprising adding a first anionic polymer, adding a cationic polymer in an amount sufficient to complex the organic contaminants, and adding a second anionic polymer.

The sequential addition of the ionic polymers described herein to a wastewater stream is an effective method of clarifying contaminated wastewater and is, in one embodiment, superior to the use of any one of the ionic polymers alone and superior to any combination of only two steps of ionic polymer addition. In fact, for one embodiment of the invention, it is believed that the results provided by the particular sequence of ionic polymer additions described herein are superior to the results that would be expected of the sequential treatment regimen on the basis of the results provided by use of any of the ionic polymers separately, or in another sequence.

Moreover, in preferred embodiments, the sequence of ionic polymer additions described herein provides a synergistic effect. As used herein, the term “synergism” refers to an interaction of two or more materials that result in an effect that is greater than the sum of their effects taken independently.

Thus, the present invention, in one embodiment, takes advantage of the fact that the particular sequence of ionic polymers added to a contaminated wastewater stream has a greater efficacy than the addition of any of the ionic polymers alone.

The synergistic effects of some embodiments of the present invention's sequential treatment regimen encompass additional unexpected advantages for clarification of contaminated wastewaters. Such additional advantages include, but are not limited to, lowering the required amounts of the conventional chemical treatments and reducing the associated costs thereof.

Moreover, another unexpected benefit of the present method is that the coagulated product of the process, the coagulated solids, have an unexpectedly high angle of repose, which permits them to be gathered in a significantly taller pile than solids from conventional processes. This permits a higher loading of solids per unit of land area, and thus conserves the amount of land area that is required for dewatering, storage and disposal.

While only three steps of ionic polymer addition have been described above, the present invention is not intended to be limited to solely three steps of flocculant and/or coagulant addition. For example, additional cationic polymer and/or anionic polymer may be added without departing from the scope of the present invention. In particular, a fourth step of ionic polymer addition may comprise the addition of a further amount of either the first or the second anionic polymer if it becomes apparent that a sufficient amount of either the first or the second anionic polymer was not present.

Likewise, additional components may be added before, during, or after the addition of any of the three ionic polymers, or as additional steps after the addition of the three steps of ionic polymers. For example, several additional components may be added that are selected from, but are not limited to: pH adjusters, metal salts, dewatering aids, anti-foaming compounds, and surfactants.

Although not wishing to be bound by this or any other theory, it is believed that during the first ionic polymer addition, the first anionic polymer interacts with colloidal materials such as clays and dissolved metals such as Ca²⁺ and/or Mg²⁺ ions. The subsequent addition of the cationic polymer causes the formation of a complex between the cationic polymer and the organic humates. For example, the cationic polymer forms a coacervate with the humate, having a limited solubility depending upon the molecular weight of the humates and the polymer. Finally, the addition of the second anionic polymer causes the flocculation of the solids for efficient dewatering.

It is believed that the addition of the second anionic polymer is important because cationic polymers are generally more environmentally toxic than anionic polymers. It is thought that the second anionic polymer helps to detoxify any residual cationic polymer.

Following the addition of the second anionic polymer, the flocculated solids can be separated from the treated stream by known separation processes such as sedimentation, flotation, filtering, centrifugation, belt press dewatering, decantation, or combinations of such processes. The separated solids can subsequently be recovered and used in numerous applications

After treatment, the clarified water may be re-used or returned to the environment by way of a suitable waterway. Non-limiting examples of suitable waterways include spillways, rivers, streams, lakes, industrial impoundments, and the like. As used herein, the term “spillway” refers to a waterway beginning at a point of discharge from a final settling pond at a water treatment site and ending where the water in the waterway enters a naturally occurring waterway through gravity flow.

In one embodiment, the methods of the present invention are used to remove contaminants from wastewater generated during the mining of titanium dioxide. The methods of the present invention are particularly effective for removing the high percentage of solids (about 6%) found in wastewater generated from titanium dioxide mining, of which almost half are organic materials. In this embodiment, the intermixing of the first anionic polymer, the cationic polymer and the second anionic polymer with the wastewater is carried out by pumping the wastewater through a pipe at a known flow rate and adding separate liquid solutions containing the first anionic polymer, the cationic polymer and the second anionic polymer into the wastewater flowing through the pipe at three separate points along the length of the pipe. As used herein to describe fluids that contain the ionic polymers, the term “solutions” is meant to include true solutions, as well as emulsions, suspensions, and dispersions. Alternatively, each one, or all of, the ionic polymers can be added in dry form and allowed to dissolve in situ.

It is preferred that the flow rate of the wastewater, the relative amounts of the first anionic polymer, the cationic polymer and the second anionic polymer that are added to the wastewater flowing through the pipe, and the relative location of the points of addition of the first anionic polymer, the cationic polymer and the second anionic polymer along the pipe are designed to provide:
a concentration of first anionic polymer in the wastewater of between 10 ppm and 100 ppm for a period of between about 0.1 minute and 5 minutes before the addition of the cationic polymer;
a concentration of cationic polymer in the wastewater of between 50 ppm and 300 ppm for a period of between about 0.5 minutes and 5 minutes before the addition of the second anionic polymer; and
a concentration of second anionic polymer in the wastewater of between 2 ppm and 20 ppm for a period of between about 0.05 minutes and 2 minute before the discharge of the wastewater from the pipe.

In a preferred embodiment, the first anionic polymer is a copolymer comprising about 5 to about 50 mol percent sodium acrylate and with the remainder being acrylamide; the cationic polymer is poly(diallyldimethylammonium chloride), and the second anionic polymer is a copolymer comprising about 5 to about 50 mol percent sodium acrylate and with the remainder being acrylamide.

Sequential addition of such ionic polymer treatments encompasses both relatively short and relatively long periods between the additions of each of ionic polymers of the present method. For example, suitable times for contacting the wastewater with the first anionic polymer prior to the addition of the cationic polymer range between about 0.1 and about 5 minutes, preferably between about 0.2 and about 2 minutes, and more preferably between about 0.4 minutes to about 1.2 minutes. Suitable times for contacting the wastewater containing the first anionic polymer with the cationic polymer prior to addition of the second anionic polymer range between about 0.5 and 5 minutes, preferably between about 1 and about 4 minutes, and more preferably between about 2 and about 3 minutes. After the addition of the second anionic polymer, it is preferred that the wastewater containing the ionic polymers is intermixed for a period of between about 0.05 and 3 minutes, preferably between about 0.1 and 2 minutes, and more preferably between about 0.2 and 1 minute, before discharge of the wastewater from the pipe or other mixing system.

After the treated wastewater is discharged from the treatment system, the treated wastewater may be allowed to stand for a long period of time to allow for the complete settling of the agglomerated solids. The duration required for settling or subsidence of the solids can be on the order of minutes, hours, days or even weeks.

In some embodiments, the ionic polymers are high molecular weight bridging flocculants while in others one of the polymers is a bridging flocculant and the other is a lower molecular weight polymer, for instance of the type that would often be referred to as a coagulant.

Proper polymer selection is important to the rapid interaction of the ionic polymers with the solids, as well as to the formation of agglomerates and their subsequent settling. Flocculant and/or coagulant polymers can vary in molecular weight, structure (linear vs. branched), amount of charge, charge type (anionic, cationic or nonionic) and composition.

As used herein, the term “coagulants” are chemicals that cause very fine particles to clump together into larger particles, thus, making it easier to separate the solids from the water by settling, skimming, draining or filtering.

Coagulants can be a liquid or a solid and can be added in batch format or continuously. As used herein, the term “coagulation” refers to the destabilization of colloids by neutralizing the forces that keep them apart. Cationic coagulants provide positive electric charges to reduce the negative charge of the colloids. As a result, the particles collide to form larger particles (flocs).

As used herein, the term “flocculant” is a long-chain polymer molecule that is able to attach to fine solid particles causing them to join together to form larger particles or aggregates.

One component of the present invention is a cationic polymer. As used herein, the terms “cationic polymer” means any polymer comprised of cationic repeating units and optionally nonionic repeating units, which carries or is capable of carrying a positive charge when dissolved in water. Some cationic polymers are made from cationic monomers while others become cationic after polymerization or after dissolution in water.

Cationic polymers are used extensively in wastewater treatment as flocculants, coagulants, and as dewatering aids in many different processes. These products are available in dry, emulsion, dispersion, and solution forms. A common characteristic of these polymers is a net cationic charge with the charge density depending upon the nature of the polymer. Exemplary cationic polymers can be branched or linear and can have relatively high molecular weights or relatively low molecular weights and can have a broad range of ionic charge. As known to one of skill in the art, there are numerous combinations of these cationic polymers that exist with their molecular weights ranging from a few hundred to a few million Daltons.

The cationic polymeric material may be a homopolymer or a copolymer of two or more monomer types. As used herein, the term “copolymer” refers to polymers that contain two or more different repeating units that can be arranged randomly or in blocks. As used herein, the term “homopolymer” refers to a polymer consisting of a single type of repeating unit.

The cationic polymers may also be terpolymers or contain multiple monomeric repeating units. The cationic polymers of the present invention may also be a mixture of two or more polymers. The polymer may be a naturally occurring cationic polymeric material or a modified naturally occurring cationic polymer, but is preferably a synthetic polymer.

The cationic polymer may be formed from a water-soluble ethylenically unsaturated monomer or monomer blend. The polymer may be formed from monomers of which substantially 100% are water-soluble cationic ethylenically unsaturated monomers. In one embodiment, the cationic polymers are formed from a water-soluble blend of cationic and non-ionic ethylenically unsaturated monomers. In some embodiments, the cationic polymer used is quaternized, giving a broader effective pH range. In another embodiment, the cationic polymers, which are suitable for use with the methods of the present invention include, but are not limited to any water-soluble polymer related monomer which carries or is capable of carrying a cationic charge when dissolved in water.

Cationic polymers that are useful herein may also be high molecular weight vinyl addition polymers which incorporate a cationic functional group. These polymers are generally homopolymers of water soluble cationic vinyl monomers, or may be copolymers of a water soluble cationic vinyl monomer with a nonionic monomer such as acrylamide or methacrylamide. The polymers may contain only one cationic vinyl monomer, or may contain more than one cationic vinyl monomer.

The cationic polymers may be prepared from as little as 1 mole percent cationic monomer to 100 mole percent cationic monomer, or from a cationically modified functional group on a post polymerization modified polymer. In one embodiment, the cationic polymers of the present invention will have at least 5 mole percent of cationic monomer or functional group, and in other embodiments, at least 10 weight percent of cationic monomer or functional group.

In one embodiment, the cationic polymers that are useful in the methods of the present invention include, but are not limited to, those cationic polymers, which are found in generally three classes, namely polyamines, polymers of diallyl dimethyl ammonium halides (e.g. DADMAC), polyacrylamides (PAM), and mixtures thereof.

In general, polyamines tend to have higher charge densities than those of the DADMAC or PAM type polymers. These cationic solution polymers are often referred to as polyquaternary amines or simply polyamines. However, it should be noted that the term polyamine is used to refer to any chemical containing more than one amine group, including those which are not quaternized. Polyamines are typically low to medium molecular weight, can be linear or branched and are usually more than 20% active. Polyquaternary amines are also pH insensitive and function well over a broad pH range.

The polyamines can be subdivided into the urea/formaldehyde types, melamine/formaldehyde types, aniline/formaldehyde types, ethylenedichloride/ammonia types, dicyandiamide/formaldehyde types, the epichlorohydrin/amine types, and the dicyandiamide/amine types. The dicyandiamide/amine types are exemplified by dicyandiamide/diethylenetriamine.

Still other cationic polymers that are suitable with the methods provided herein include, but are not limited to, polymers of diallyl dialkyl ammonium halides. Polymers made from diallyl dialkyl ammonium halide monomers are similar to polyamines in their characteristics with the additional advantage that the diallyl dialkyl ammonium halide monomers can be copolymerized with other monomers such as acrylamide.

In one embodiment, the diallyl dialkyl ammonium halide that is suitable for use with the methods of the present invention, is diallyl dimethyl ammonium chloride (DADMAC) or alternate salts thereof.

The DADMAC containing polymer contains, in one embodiment, at least 10 percent or greater of the DADMAC monomer. In other embodiments, the DADMAC polymer contains at least 50 mole percent or greater of the DADMAC monomer. In further embodiments, the DADMAC polymer contains at least 70 mole percent DADMAC. In still further embodiments, the DADMAC polymer contains at least 80 mole percent DADMAC. The DADMAC polymer may also contain 100 mole percent DADMAC in which case the DADMAC polymer is a homopolymer of DADMAC. In still other embodiments, the DADMAC polymers contain at least 70 to 100 mole percent DADMAC, or an equivalent salt thereof.

In one embodiment, the cationic polymers are polyacrylamide-based, with cationic functional monomers incorporated into the polymerization process to form copolymers of varying degrees of ionicity. Cationic polyacrylamides can consist of acrylamide and cationic monomers such as dimethyl aminoethyl acrylate methyl chloride, dimethyl aminoethyl methacrylate methyl chloride, acrylamidopropyl trimethyl ammonium chloride, methacrylamidopropyl trimethyl ammonium chloride or diallyl dimethyl ammonium chloride.

In other embodiments, the cationic polymers suitable for use with present invention include, but are not limited to, dialkylaminoalkyl (meth)-acrylates and acrylamides, as acid addition or, preferably, quaternary ammonium salts. In one embodiment, the cationic polymers of the present invention are acrylates and (meth)acrylates, including the di-C₁₋₄alkylaminoethyl(meth)acrylates and the di-C₁₋₄alkylaminopropyl(meth)acrylamides. In other embodiments, the cationic polymers are dimethylaminoethyl(meth)acrylates and dimethylaminopropyl(meth)acrylamide as quaternary ammonium salts.

Alternatively, certain cationic polymers, such as polyacrylamide, may be modified or derivatized after polymerization by the Mannich reaction to produce a cationic vinyl polymer useful in the invention. Therefore, additional cationic polymers include Mannich polymers, which are produced by performing the Mannich reaction on the homopolymer of acrylamide. The process results in a highly charged, high molecular weight cationic polymer. These Mannich polymers can also be quaternized to make them even more useful.

Also encompassed by the methods of the present invention include such cationic polymers as the polyethyleneamines, polyethylenimines, cationic starches, lime, melamine/formaldehyde polymers, unquaternized polyamines, and modified tannins and gums.

Still other suitable cationic polymers include, for example, polycyandiamide formaldehyde polymers, amphoteric polymers, diallylaminoalkyl(meth)acrylate polymers and dialkylaminoalkyl(meth)acrylamide polymers.

The cationic polymer may also be chosen from condensation polymers that are derived from the reaction of ethylene dichloride and ammonia or the reaction of ethylene dichloride, ammonia, and ethylenediamine, and other polyamines. Thus, in one embodiment, the condensation cationic polymer is derived from the reaction of epichlorohydrin (EPI) and dimethylamine (DMA), either in the presence or absence of any cross-linking agents, to form either linear EPI-DMA polymers or to form branched and/or cross-linked EPI-DMA cationic polymers. These branched and cross-linked EPI-DMA cationic polymers may be obtained by reacting epichlorohydrin and dimethylamine in the presence of prescribed amounts of any cross linking agent chosen from the group consisting of ammonia, ethylene diamine, hexamethylenediamine, and mixtures thereof.

Other suitable low molecular weight polymers include polyethylene imine and polyamines, such as polyamine epichlorohydrin reaction products.

Suitable cationic monomers useful in making the cationically charged homopolymers of the present invention include, but are not limited to dimethylaminoethyl methacrylate, dimethylaminoethyl acrylate, diethylaminoethyl acrylate, diethylaminoethyl methacrylate or their quaternary ammonium forms made with dimethyl sulfate or methyl chloride, Mannich reaction modified polyacrylamides, diallylcyclohexylamine hydrochloride, diallyldimethylammonium chloride, methacrylamidopropyltrimethylammonium chloride and allyl amine.

The cationic polymer can also include such cationic monomers as ethylenically unsaturated quaternary ammonium, phosphonium or sulfonium ions, methyl chloride quaternary salt of diethylaminoethyl acrylate, dimethyl sulfate salt of diethylaminoethyl acrylate, dimethylaminoethyl acrylate, dimethylaminoethyl methacrylate, diethylaminoethyl methacrylate, dimethylaminopropyl methacrylamide, dimethylaminopropyl acrylamide, diallyldimethyl ammonium chloride and diallyldiethyl ammonium chloride.

Such cationic monomers can be quaternary ammonium salts of dialkylaminoalkyl(meth)acrylamides, dialkylaminoalkyl(meth)acrylates and diallyl dialkyl ammonium chloride.

Still other cationic polymers suitable for use with the present invention include such cationic monomers as dialkylaminoalkyl acrylates and methacrylates and their quaternary or acid salts, including, but not limited to, dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate, methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt, dialkylaminoalkylacrylamides or methacrylamides and their quaternary or acid salts such as acrylamidopropyltrimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, poly(diallylamine)-epihalohydrin resins, diethylaminoethylmethacrylate and diallyldialkylammonium halides such as diallyldiethylammonium chloride and diallyldimethyl ammonium chloride.

Also useful in the methods of the present invention include, but are not limited to, various copolymers of cationic homopolymers. Cationic copolymers that are suitable for use with the present invention include copolymers of acrylamide with a cationic monomer, cationically modified acrylamide or a polyamine. The amount of cationic monomer is usually 10 to 80%, often 10 to 60%, by weight with the remainder usually being acrylamide or other water-soluble ethylenically unsaturated monomer.

The cationic copolymers suitable for use with the present invention also include a copolymer of acrylamide and diallyl dimethyl ammonium chloride, a copolymer of acrylamide and dialkylaminoalkyl(meth)acrylates, a copolymer of acrylamide and dialkyldiaminoalkyl(meth)acrylamides, and a copolymer of dimethylamine and epichlorohydrin. Representative cationic copolymers of (meth)acrylamide include copolymers of (meth)acrylamide with dimethylaminoethyl methacrylate, dimethylaminoethyl acrylate, diethylaminoethyl acrylate, diethylaminoethyl methacrylate or their quaternary ammonium forms made with dimethyl sulfate or methyl chloride, Mannich reaction modified polyacrylamides, diallylcyclohexylamine hydrochloride, diallyldimethylammonium chloride, methacrylamidopropyltrimethylammonium chloride and allyl amine. Still other suitable cationic copolymers include copolymers of dialkylaminoalkyl-(meth)acrylate and -(meth)acrylamide monomers with acrylamide or other non-ionic monomer.

Copolymers of DADMAC which contain up to 30 weight percent acrylamide are particularly useful in the present invention.

A first anionic polymer and a second anionic polymer are also used in the present invention. As used herein, the terms “anionic polymer” mean any polymer comprised of an anionic repeating unit and optionally nonionic repeating units, which carries or is capable of carrying an anionic charge when dissolved in water.

Such first anionic polymers and second anionic polymers may be homopolymers, copolymers, terpolymers or contain multiple monomeric repeating units. The first anionic polymers and the second anionic polymers may be used in solid, powder form, after dissolution in water, as dispersions, or may preferably be used as water-in-oil emulsions, wherein the polymer is dissolved in the dispersed water phase of these emulsions.

The preparation of high molecular weight anionic polymers and copolymers are well known and described in numerous publications and patents. These anionic polymers are most commonly prepared via aqueous solution, non-aqueous media and emulsion polymerization techniques. The final form of the polymer may be as a solid powder, aqueous solution at low concentrations (<50%) or in a nonaqueous solution at low concentrations (<2.0%) with a solvent for the polymer such as dioxane, methanol, ethanol, 2-propanol, dimethyl formamide or the like. Also, the anionic polymer may be in the form of a gel which is a very high polymer concentration in water (>10%) and in the form of a water-in-oil emulsion. See Mark, H., et al., Encyclopedia of Polymer Science and Technology, 1:197-226 (1964).

The choice of first anionic polymers and second anionic polymers is based upon several factors including the ability of the individual monomers to polymerize with the desired comonomer, the use of the produced polymer, and cost.

In one embodiment, the anionic polymers that are suitable for use as the first anionic polymer and the second anionic polymer in the methods of the present invention include, but are not limited to, water soluble anionic vinyl addition polymers containing monomers from the group consisting of acrylic acid, 1,2-dichloroacrylic acid, 2-methyl-cis-acrylic acid, 2-methyl-trans-acrylic acid, ethylene sulfonic acid, fumaric acid, chlorofumaric acid, methylfumaric acid, itaconic acid, vinyl phosphonic acid, allyl sulfonic acid, allyl phosphonic acid, sulfomethylated acrylamide, phosphonomethylated acrylamide maleic acid, allylacetic acid, dichloromaleic acid, methylmaleic acid, methacrylic acid, styrene sulfonic acid, crotonic acid, maleic anhydride, Alken® Solutions A4040L, Ultimer 00LT053, vinyl sulfonic acid, fumaric acid, fumaric anhydride, acrylamide, 2-acrylamido-2-methylpropanesulfonic acid (AMPS®), and the water-soluble alkali metal, alkaline earth metal, and ammonium salts thereof, and mixtures thereof, or polymers obtained by reacting amide containing polymers with materials capable of providing for sulfonate functionality on an acrylamide backbone. Such anionic polymers are further described, for example, in U.S. Pat. Nos. 4,643,801; 4,795,531; and 5,126,014.

In another embodiment, the anionic polymers that are suitable for use in the methods of the present invention are ethylenically unsaturated carboxylic or sulphonic acids, generally as their water-soluble alkali metal salts, such as, 2-acrylamido-2-methyl propane sulphonic acid (AMPS®), methacrylic acid and acrylic acid, and salts thereof, and mixtures thereof. The anionic polymers may, in other embodiments, comprise sulfonate or phosphonate containing anionic polymers which have been synthesized by derivatizing acrylamide polymers in such a way as to obtain sulfonate or phosphonate substitution, or admixtures thereof. In another embodiment, the anionic polymers suitable for the invention are polymers containing hydroxamic acid groups or salts thereof.

In addition to the anionic monomers described herein and the anionic homopolymers derived therefrom, the anionic high molecular weight anionic polymer may also contain neutral monomers such as acrylamide, methacrylamide, methylacrylate, ethylacrylate, and similar monomers of a neutral character. These copolymers are preferably those copolymers of acrylic acid or sodium acrylate with acrylamide and preferably are those copolymers containing from about 10 or to about 90, most preferably between about 20-80, mole percent of an anionic monomer chosen from the group consisting of acrylic acid, sodium acrylate, methacrylic acid, and AMPS® and from about 90 to about 10, most preferably 80-20, mole percent of at least one nonionic monomer chosen from acrylamide, methacrylamide, and the like.

Thus, in one embodiment, the first anionic polymer and the second anionic polymer comprises a water-soluble anionic copolymer having units derived from the reaction between sodium acrylate and acrylamide. Such a copolymer has, in one embodiment, from between 5-50 mole percent of sodium acrylate, and in other embodiments, form between 10-30 mole percent sodium acrylate

The first anionic polymer and the second anionic polymer can also comprise a water-soluble anionic copolymer consisting of units derived from the reaction between acrylamide and 2-acrylamido-2-methylpropanesulfonic acid (AMPS®).

In still other embodiments, the first anionic polymer and the second anionic polymer are each separately selected from sulfonated novolac, modacrylic, anionic starch, anionic guar gum, anionic polyvinyl acetate, and urethanes, and mixtures thereof.

Anionic and cationic polymers are also disclosed, for instance, in U.S. Pat. Re No. 31,900 to Halverson, U.S. Pat. No. 3,002,960 to Kolodny, U.S. Pat. Nos. 3,316,181 to Sakis, 3,686,109 to Aldrich, U.S. Pat. No. 3,692,673 to Hoke et al, U.S. Pat. No. 3,374,143 to Stephenson, U.S. Pat. No. 4,010,131 to Phillips et al, U.S. Pat. No. 4,451,628 to Damman, U.S. Pat. No. 4,565,635 to Du et al, U.S. Pat. No. 4,702,844 to Flesher et al, U.S. Pat. No. 4,693,830 to Thorton et al, U.S. Pat. No. 4,695,453 to Tuominen et al, U.S. Pat. No. 4,147,681 to Lim et al, and U.S. Pat. No. 4,770,803 to Forsberg.

Also encompassed by the present invention are several new types of polymers. Recent advances in polymer design include both hydrophobically associative block copolymers (HABCs) and graft copolymers. HABCs consist of an array of block copolymers, with each block being either hydrophilic or hydrophobic. Synthetic manipulation of the functional groups in the block copolymer allows the design of a much more effective polymer.

Graft copolymers incorporate a highly charged cationic arm grafted onto a polyacrylamide backbone, resulting in a higher localized concentration of charge than would be available if the charge were distributed randomly along a conventional linear polymer's backbone. The primary advantage over linear flocculants is the optimization of the available charge sites.

The HABC and graft polymer designs include the purposeful placement of charged monomers toward the outermost ends of the radially protruding branches. This configuration maximizes charged-monomer utility for particle charge neutralization. This configuration also maximizes multiparticle contact, theoretically improving bridging activity.

In the methods of the present invention, a high or low molecular weight ionic polymer, or mixtures thereof, is added in an effective amount to reduce the number of surface negative charge sites on the suspended solids. An effective amount is dependent on several factors, including the number of surface charge sites present on the solids in the aqueous stream, the type of solid particle, and the pH of the aqueous stream. An effective amount can be determined by means available and known to those skilled in the art, using techniques such as colloidal titration.

It is preferred that the first anionic polymer is added to the wastewater in an amount between about 1-500 ppm, based on anionic polymer actives. As used herein, the terms “parts per million” or “ppm” refers to a measurement of concentration on a weight per volume basis. This term is equivalent to milligrams per liter (mg/L). It is more preferred that the first anionic polymer is added to the wastewater in an amount between about 5-150 ppm anionic polymer actives, yet more preferred is an amount between about 10-100 ppm anionic polymer actives.

It is preferred that the cationic polymer is added to the wastewater in an amount between about 1-1000 ppm, based on cationic polymer actives; more preferred is an amount between about 10-500 ppm; and yet more preferred is an amount of cationic polymer that is between about 50-300 ppm, based on cationic polymer actives.

It is preferred that the second anionic polymer is added to the wastewater in an amount between 0.1-300 ppm, based on anionic polymer actives, an amount of between 1-100 ppm anionic polymer actives is more preferred, and an amount of between 2-20 ppm anionic polymer actives is yet more preferred.

Alternatively, the effective amounts of the polymer additions can be expressed relative to the solids content in the wastewater. In this manner, it is preferred that the first anionic polymer is added to the wastewater in an amount between about 0.1 and 10 mg of the first anionic polymer actives per gram of solids, an amount of between about 0.5 and 5 mg of the first anionic polymer actives per gram of solids is more preferred, and an amount of between about 0.87 and 1.5 mg of the first anionic polymer actives per gram of solids is yet more preferred.

It is preferred that the cationic polymer is added to the wastewater in an amount between about 0.5 and 100 mg of cationic polymer actives per gram of solids. An amount of between about 1.0 and 20 mg of the cationic polymer actives per gram of solids is more preferred, and an amount of between about 1.7 and 4.3 mg of the cationic polymer actives per gram of solids is yet more preferred.

It is preferred that the second anionic polymer is added to the wastewater in an amount between about 0.01 and 10 mg of anionic polymer actives per gram of solids. An amount of between about 0.05 and 2 mg anionic polymer actives per gram of solids is more preferred, and an amount between about 0.1 and 0.25 mg anionic polymer actives per gram of solids is yet more preferred.

As used herein, the term “charge density” refers to a way of identifying ionic (e.g. cationic and anionic) polymers by their charge, both the type of charge and its magnitude. On the other hand, nonionic polymers do not have any charge-bearing groups, thus they do not have a charge density.

When dissolved in water, anionic polymers become negatively charged, while cationic polymers become positively charged. The charge-bearing group on anionic polymers is generally located on a pendant group protruding from the polymer chain backbone. The charge on anionic polymers is pH sensitive. Anionic polymers function best at a pH equal to and above 6, but are known to be effective across a wide pH range.

The charge-bearing group of cationic polymers is derived from nitrogen in the form of a primary, secondary, tertiary or quaternary amine group. Those containing primary, secondary or tertiary amines are sensitive to pH. The charge on these polymers drops off quickly as the pH rises above 6, thus cationic polymers function best at a pH equal to and below 6. In cationic polymers, the charge can be located on a pendant group or may be in the backbone of the polymer chain.

For purposes of the present invention, charge densities for the cationic polymers can range from between about 0.1 to 24 milliequivalents per gram of polymer product (meq/g). In other embodiments, the charge densities for the cationic polymers can range from between about 0.5 meq/g to about 5 meq/g. In still further embodiments, the charge density for the cationic polymer is about 1.2-2.4 meg/g. These cationic polymers are effective over a pH range of 3 to 8 and, in some cases, even higher, depending on the nature of the cationic monomer used.

Likewise, charge densities for the anionic polymers can range from between about 0.1 to about 10 meq/g based on weight of product. In other embodiments, the charge densities for the first anionic polymer and the second anionic polymer can range from between about 0.5 meq/g to about 5 meq/g. In still further embodiments, the charge density for the first anionic polymer and the second anionic polymer is about 0.4 to about 1.2 meg/g.

As used herein, the terms “molecular weight” refer to the weight in Daltons of a polymer. Molecular weights may be determined by measurement of sedimentation rate in an ultracentrifuge, by light-scattering photometry, or by other methods. These methods determine an average molecular weight for the molecules in the sample. The number average molecular weight determined by the ultracentrifuge method gives a value that is equal to the weight of the sample divided by the number of molecules in the sample. This number average molecular weight can also be determined by other methods based on measurement of colligative properties.

The light-scattering method determines what is called the weight average molecular weight. Although this may be the same value as the number average molecular weight if all the molecules have nearly the same weight, it will be higher if some of the molecules are heavier than others.

The distribution of molecular weights in a polymer sample is often described by the ratio of the weight average molecular weight to the number average molecular weight. This ratio is the Polydispersity Index (PDI).

In general, molecular weights for water treatment polymers range from a few thousand to tens of millions of Daltons. High molecular weight polymers, those whose molecular weight is above 1 million, are shear sensitive meaning that their chains can be broken into smaller fragments by excessive mixing.

Therefore, in one embodiment, the cationic polymers that are useful in the methods of the present invention include those cationic polymers having a molecular weight in the range between about 2,000 to about 10,000,000 Daltons and in other embodiments, between about 10,000 and 500,000 Daltons. If the cationic polymer is a high-molecular weight copolymer, then the molecular weights of these copolymers can range from 4,000,000 to 16,000,000 Daltons. The DADMAC cationic polymers have, in another embodiment, a weight average molecular weight ranging from about 25,000 to about 150,000, with the preferred molecular weight ranging from about 50,000 to about 150,000 Daltons. Measured by gel permeation chromatography (GPC), the molecular weight of the cationic polymers is usually above 50,000 and often above 100,000, but frequently below 1,000,000 or 3,000,000.

In another embodiment, the first anionic polymer and the second anionic polymer that are useful in the methods of the present invention include those anionic polymers that are high molecular weight anionic polymers and which have a molecular weight of at least 1,000,000 Daltons or greater, and in other embodiments, having a molecular weight ranging from between about 1,000,000 to about 50,000,000 Daltons.

As used herein, the term “viscosity” refers to a measure of the resistance to flow of a liquid and is directly related to several properties of the polymers described herein. The first of these properties is the concentration of the polymer in solution. For a given charge density and molecular weight, the higher the concentration, the higher the viscosity. Another property which affects viscosity is the molecular weight. For a given charge and concentration, the higher the molecular weight, the higher the viscosity. Another property is charge density. For a given molecular weight and concentration, higher charge densities give higher viscosities.

Finally, the structure of the polymer chains often has an effect on the viscosity. Branched polymers often give a creamy or syrupy viscosity. Linear polymers will give a stringy or “leggy” type of viscosity. By measuring this “stringiness” (known as pituity or elongational viscosity), a relative measure of the polymer's linearity can be obtained.

As used herein, the terms “Reduced Specific Viscosity” (RSV) refers to an indication of polymer chain length and average molecular weight. The RSV is measured at a given polymer concentration and temperature and typically is expressed in terms of deciliters per grams (dl/g). The RSV values reported here are measured by viscometry at 0.045 weight percent polymer actives in the presence of 1 normal sodium nitrate electrolyte.

In one embodiment, the cationic polymer has a RSV of between about 0.05 and 20 dl/g, and in further embodiments, between about 0.5 and 10 dl/g, and in other embodiments, between about 0.1 and 6 dl/g and in still other embodiments, between about 1.0 and 2.0 dl/g.

For the first anionic polymer and the second anionic polymer, the RSV should be between about 1.0 and 100 dl/g, and in further embodiments, between about 10 and 60 dl/g, and in other embodiments, between about 20 and 50 dlI/g and in still other embodiments, between about 25 and 40 dl/g.

The following examples describe embodiments of the invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples.

### EXAMPLE 1

This example demonstrates the efficacy of different treatment schemes for clarification of high-solids process water generated in titanium dioxide mining operations.

Process water having a total solids content of about 6% by weight, of which about 50% by weight are organic materials, was collected from a titanium dioxide mining sludge pond. Jar tests were used to determine the effectiveness of different treatment schemes for clarifying the wastewater.

In the tests, 400 mL of the dark brown process water is mixed in a 600 mL beaker on a gang-stirrer jar testing apparatus and polymer solutions, 0.1-10% as product, are added sequentially with mixing. After the final polymer addition, the mixing is stopped and the formation of flocs is observed. In many cases, no flocculation or separation occurred, while in the most preferred cases, large flocs were formed and a sludge layer was observed to form at the bottom of the beaker and clarified, water-white supernate was produced.

TABLE 1
Performance of various ionic polymer addition schemes for
clarification of titanium dioxide process water.

| Treatment | | |
|---|---|---|
| No. | Treatment steps | Results |
| 1 | Cationic flocculants | No separation |
| 2 | Anionic flocculants | No separation |
| 3 | Cationic coagulants | No separation and produces |
| | | high viscosity slurry |
| 4 | Cationic coagulants followed | No separation |
| | by anionic flocculants | |
| 5 | Lime followed by anionic | Separation occurs, but with |
| | flocculant | high sludge volume and high |
| | | dilution water requirements |
| 6 | EPI-DMA coagulant | Some coagulation, but poor |
| | | quality |
| 7 | Anionic polymer followed by | Small flocs, poor separation |
| | cationic coagulant | |
| 8 | Anionic polymer followed by | Large flocs, good separation |
| | cationic coagulant followed | and clear effluent |
| | by anionic polymer | |

The data from these tests showed that the addition of an anionic polymer, followed by the addition of a cationic polymer, in turn followed by the addition of another anionic polymer, with each addition being followed by a period of mixing, provided clarification that was unexpectedly superior to that provided by the other tested methods.

### EXAMPLE 2

This example illustrates the clarification of process water generated during titanium oxides mining operations.

Process water generated during the mining of ore for the production of titanium dioxide typically has a total solids content of about 6% by weight, and about 50% of the solids are organic materials. The process water can be clarified by pumping the solids-containing process water from the pond or tank in which it is collected, feeding the three ionic polymers that are part of the present invention into the process water as it flows through a pipe, and separating the flocculated solids from the process water. If desired, the clarified process water can be recycled back into the pond or tank from which it was drawn.

In one treatment system, a centrifugal pump is set up to withdraw process water from a pond and to pump the wastewater through 1180 feet of ½″ sch. 40 pipe at the rate of 6 gallons per minute. This results in a velocity in the pipe of about 6.35 feet per second, and a total duration of time of the wastewater in the pipe of about 3 minutes.

The pipe is fitted with feedpoints at three locations to facilitate the addition of a first anionic polymer, a cationic polymer, and a second anionic polymer. The feed point for the first anionic polymer is directly before the pump inlet. The feed point for the cationic polymer is approximately 114 ft downstream of the pump, and the feed point for the second anionic polymer is approximately 75 ft from the discharge end of the pipe (1105 ft downstream of the pump). During operation, the duration of time during which the first anionic polymer is intermixed with the wastewater prior to the addition of the cationic polymer is about 0.3 minutes. The duration of time during which the cationic polymer is intermixed with the wastewater containing the first anionic polymer is about 2.6 minutes, and the duration of time during which the second anionic polymer is intermixed with the wastewater containing the first anionic polymer and the cationic polymer is approximately 0.2 to 0.3 minutes. Total duration in the pipe is about 3 minutes.

At the first feedpoint a solution of poly(sodium acrylate-co-acrylamide) (the first anionic polymer) is continuously pumped into the wastewater at a rate sufficient to bring the concentration of the first anionic polymer in the wastewater to about 60 ppm (based on polymer actives). At the second feed point, a solution of polyDADMAC (the cationic polymer) is continuously pumped into the wastewater at a rate sufficient to bring the concentration of the cationic polymer to about 100 ppm (based on polymer actives), and at the third feed point, a solution of poly(sodium acrylate-co-acrylamide) (the second anionic polymer) is pumped into the wastewater at a rate sufficient to bring the concentration of the second anionic polymer to about 12 ppm (based on polymer actives).

After passage through the pipe, the treated process water is discharged from the pipe onto a flat surface, such as onto land, so that the flocculated solids separate from the water by sedimentation to form a sludge, and clarified Water flows away from the deposited sludge, which is left to dry. Before treatment the wastewater contains roughly 6% by weight of solids and after treatment the clarified water contains less than about 0.5% by weight of solids. The color, suspended solids, and turbidity of the wastewater are all reduced by the treatment, and the clarified water can be recycled to use in the mining, or ore processing operations.

All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions without departing from the scope of the invention, it is intended that all matter contained in the above description shall be interpreted as illustrative and not in a limiting sense.

1. A method of removing contaminants from a wastewater, comprising:
a) intermixing a first anionic polymer with the wastewater;
b) intermixing a cationic polymer with the wastewater and forming a complex between the contaminants and the cationic polymer; and
c) intermixing a second anionic polymer with the wastewater and forming a floc which contains the contaminants.

2. The method according to claim 1, further comprising separating the floc which contains the contaminants from the wastewater stream.

3. The method according to claim 2, wherein separating the floc from the wastewater stream comprises removing the wastewater from a waste pond prior to step a) and transferring wastewater after step c) onto the surface of land adjacent the pond and allowing the floc to settle from the wastewater and remain on the land while wastewater that is free of floc flows back into the pond.

4. The method according to claim 1, wherein the wastewater contains solid particles.

5. The method according to claim 1, wherein the wastewater is generated during the mining of titanium dioxide.

6. The method according to claim 1, wherein the contaminants predominantly comprise organic materials.

7. The method according to claim 6, wherein the organic materials comprise humates.

8. The method according to claim 1, wherein the contaminants predominantly comprise inorganic materials.

9. The method according to claim 8, wherein the inorganic material comprises at least one material selected from clays, metal oxides, minerals, fly ash, silt, phosphate rock fines, phosphogypsum fines, red mud, coal fines, kaolin, coal refuse, sand and gravel wash water, or a mixture thereof.

10. The method according to claim 1, wherein the cationic polymer is selected from the group consisting of polyamines, poly(diallyl dimethyl ammonium halides), polyacryamides, and mixtures thereof.

11. The method according to claim 10, wherein the polyamine cationic polymer is selected from the group consisting of dicyandiamide/formaldehydes, epichlorohydrin/amines, dicyandiamide/amines, and mixtures thereof.

12. The method according to claim 11, wherein the dicyandiamide/amine polyamine comprises dicyandiamide/diethylenetriamine.

13. The method according to claim 10, wherein the cationic polymer is a polymer of a diallyidimethylammonium halide, or salts thereof.

14. The method according to claim 13, wherein the diallyldimethylammonium halide cationic polymer is polydiallyldimethylammonium chloride, or salts thereof.

15. The method according to claim 1, wherein the cationic polymer is a polymer of dialkylaminoalkyl(meth)-acrylate.

16. The method according to claim 15, wherein the dialkylaminoalkyl(meth)-acrylate cationic polymer is a polymer of a monomer that is selected from the group consisting of di-C₁₋₄alkylaminoethyl(meth)acrylates, di-C₁₋₄alkylaminopropyl(meth)acrylamides, dimethylaminopropyl(meth)acrylamide, dimethylaminoethyl (meth) acrylates, and mixtures thereof.

17. The method according to claim 1, wherein the cationic polymer comprises a copolymer of acrylamide and at least one or more cationic functional monomers selected from the group consisting of dimethyl aminoethyl acrylate methyl chloride, dimethyl aminoethyl methacrylate methyl chloride, acrylamidopropyl trimethyl ammonium chloride, methacrylamidopropyl trimethyl ammonium chloride, diallyl dimethyl ammonium chloride, and mixtures thereof.

18. The method according to claim 1, wherein the cationic polymer is selected from the group consisting of Mannich polymers, polyethyleneamines, polyethylenimines, cationic starches, lime, epihalohydrin resins, EPI-DMA, melamine/formaldehyde polymers, unquaternized polyamines, diallylcyclohexylamine hydrochloride, modified tannins, modified gums, amphoteric polymers, and mixtures thereof.

19. The method according to claim 18, wherein the cationic polymer comprises EPI-DMA.

20. The method according to claim 1, wherein the cationic polymer is intermixed with the wastewater in an amount between about 1 ppm and about 1000 ppm based on the weight of the wastewater.

21. The method according to claim 1, wherein the cationic polymer is intermixed with the wastewater in an amount between about 10 ppm and about 500 ppm based on the weight of the wastewater.

22. The method according to claim 1, wherein the cationic polymer is intermixed with the wastewater in an amount between about 50 ppm and about 300 ppm based on the weight of the wastewater.

23. The method according to claim 4, wherein the cationic polymer is intermixed with the wastewater in an amount between about 0.5 mg and 100 mg of cationic polymer actives per gram of solid particles.

24. The method according to claim 4, wherein the cationic polymer is intermixed with the wastewater in an amount between about 1 mg and 20 mg of cationic polymer actives per gram of solid particles.

25. The method according to claim 4, wherein the cationic polymer is intermixed with the wastewater in an amount between about 1.7 mg and 4.3 mg of cationic polymer actives per gram of solid particles.

26. The method according to claim 1, wherein the first anionic polymer and second anionic polymer are each independently selected from anionic polymers containing a monomer or a water-soluble alkali metal, alkaline earth metal, or ammonium salt thereof, wherein the monomer is selected from the group consisting of acrylic acid, 1,2-dichloroacrylic acid, 2-methyl-cis-acrylic acid, 2-methyl-trans-acrylic acid, ethylene sulfonic acid, fumaric acid, chlorofumaric acid, methylfumaric acid, itaconic acid, vinyl phosphonic acid, allyl sulfonic acid, allyl phosphonic acid, sulfomethylated acrylamide, phosphonomethylated acrylamide maleic acid, allylacetic acid, dichloromaleic acid, methylmaleic acid, methacrylic acid, styrene sulfonic acid, crotonic acid, maleic anhydride, Alken® Solutions A4040L, Ultimer 00LT053, vinyl sulfonic acid, fumaric acid, fumaric anhydride, acrylamide, 2-acrylamido-2-methylpropanesulfonic acid (AMPS®), and mixtures thereof.

27. The method according to claim 1, wherein the first anionic polymer and the second anionic polymer each comprise a reaction product of an amide containing polymer and a material capable of providing a sulfonate and/or phosphonate functionality on an acrylamide backbone.

28. The method according to claim 1, wherein the first anionic polymer and the second anionic polymer each comprise an anionic copolymer containing monomer units of sodium acrylate and acrylamide.

29. The method according to claim 28, wherein the first anionic polymer and the second anionic polymer each comprise between about 5 to about 50 mole percent of sodium acrylate.

30. The method according to claim 28, wherein the first anionic polymer and the second anionic polymer each comprise between about 10 to about 30 mole percent sodium acrylate.

31. The method according to claim 1, wherein the first anionic polymer and the second anionic polymer each comprise an anionic copolymer having monomer units of acrylamide and 2-acrylamido-2-methylpropanesulfonic acid (AMPS®).

32. The method according to claim 1, wherein the first anionic polymer and the second anionic polymer are independently selected from the group consisting of sulfonated novolac, modacrylic, anionic starch, anionic guar gum, anionic polyvinyl acetate, urethanes, and mixtures thereof.

33. The method according to claim 1, wherein the first anionic polymer is intermixed with the wastewater in an amount between about 10 ppm and about 200 ppm based on the weight of the wastewater.

34. The method according to claim 1, wherein the first anionic polymer is intermixed with the wastewater in an amount between about 20 ppm and about 100 ppm based on the weight of the wastewater.

35. The method according to claim 1, wherein the first anionic polymer is intermixed with the wastewater in an amount between about 50 ppm and about 75 ppm based on the weight of the wastewater.

36. The method according to claim 4, wherein the first anionic polymer is intermixed with the wastewater in an amount between 0.1 and 10 mg of first anionic polymer actives per gram of solids.

37. The method according to claim 4, wherein the first anionic polymer is intermixed with the wastewater in an amount between about 0.5 and 5 mg of first anionic polymer actives per gram of solids.

38. The method according to claim 4, wherein the first anionic polymer is intermixed with the wastewater in an amount between about 0.87 and 1.5 mg of first anionic polymer actives per gram of solids.

39. The method according to claim 1, wherein the second anionic polymer is intermixed with the wastewater in an amount between about 1 ppm and about 40 ppm based on the weight of the wastewater.

40. The method according to claim 1, wherein the second anionic polymer is intermixed with the wastewater in an amount between about 2 ppm and about 20 ppm based on the weight of the wastewater.

41. The method according to claim 1, wherein the second anionic polymer is intermixed with the wastewater in an amount between about 5 ppm and about 10 ppm based on the weight of the wastewater.

42. The method according to claim 4, wherein the second anionic polymer is intermixed with the wastewater in an amount between about 0.01 and 10 mg of second anionic polymer actives per gram of solids.

43. The method according to claim 4, wherein the second anionic polymer is intermixed with the wastewater in an amount between about 0.05 and 2 mg of second anionic polymer actives per gram of solids.

44. The method according to claim 4, wherein the second anionic polymer is intermixed with the wastewater in an amount between about 0.1 and 0.25 mg of second anionic polymer actives per gram of solids.

45. The method according to claim 1, wherein the first anionic polymer and the second anionic polymer are both high molecular weight anionic polymers.

46. The method according to claim 1, wherein the first anionic polymer and the second anionic polymer each have an average molecular weight of at least about 1,000,000 Daltons.

47. The method according to claim 1, wherein the first anionic polymer and the second anionic polymer each have an average molecular weight of between about 1,000,000 to about 50,000,000 Daltons.

48. The method according to claim 1, wherein the first anionic polymer, the cationic polymer, and the second anionic polymer is each intermixed with the wastewater in the sequence that is specified.

49. The method according to claim 48, wherein the cationic polymer is intermixed with the wastewater during a period that is between 10 seconds and 5 minutes after the first anionic polymer is intermixed with the wastewater.

50. The method according to claim 48, wherein the cationic polymer is intermixed with the wastewater during a period that is between 30 seconds and 3 minutes after the first anionic polymer is intermixed with the wastewater.

51. The method according to claim 48, wherein the second anionic polymer is intermixed with the wastewater during a period that is between 10 seconds and 5 minutes after the cationic polymer is intermixed with the wastewater.

52. The method according to claim 48, wherein the second anionic polymer is intermixed with the wastewater during a period that is between 30 seconds and 3 minutes after the first anionic polymer is intermixed with the wastewater.

53. The method according to claim 1, wherein the intermixing of the first anionic polymer, the cationic polymer and the second anionic polymer with the wastewater comprises pumping the wastewater through a pipe at a known flow rate and adding separate liquid solutions containing the first anionic polymer, the cationic polymer and the second anionic polymer into the wastewater flowing through the pipe at three separate points along the length of the pipe.

54. The method according to claim 53, wherein the flow rate of the wastewater, the relative amounts of the first anionic polymer, the cationic polymer and the second anionic polymer that are added to the wastewater flowing through the pipe, and the relative location of the points of addition of the first anionic polymer, the cationic polymer and the second anionic polymer along the pipe are designed to provide:
a concentration of first anionic polymer in the wastewater of between 50 ppm and 100 ppm for a period of between about 0.1 minutes and 5 minutes before the addition of the cationic polymer;
a concentration of cationic polymer in the wastewater of between 100 ppm and 300 ppm for a period of between about 0.5 minutes and 5 minutes before the addition of the second anionic polymer; and
a concentration of second anionic polymer in the wastewater of between 5 ppm and 20 ppm for a period of between about 0.05 minutes and 2 minutes before the discharge of the wastewater from the pipe.

55. A method for clarifying humate-containing wastewater generated during the mining of titanium dioxide, the method comprising:
a) intermixing a first anionic polymer with the wastewater in an amount of between 10 ppm and 100 ppm, wherein the first anionic polymer is a copolymer comprising about 5 to about 50 mol percent sodium acrylate and with the remainder being acrylamide;
b) intermixing a cationic polymer with the wastewater in an amount of between 50 ppm and 300 ppm, wherein the cationic polymer is poly(diallyldimethylammonium chloride), and forming a complex between the contaminants and the cationic polymer; and
c) intermixing a second anionic polymer with the wastewater in an amount of between 2 ppm and 20 ppm, wherein the second anionic polymer is a copolymer comprising about 5 to about 50 mol percent sodium acrylate and with the remainder being acrylamide, and forming a floc which contains the contaminants.
